(19) United States
(12) Patent Application Publication
(10) Pub. No.: US 2006/0171462 A1
(43) Pub. Date: Aug. 3, 2006

(54) Video encoding method

(75) Inventor: Eric Barrau, PUTEAUX (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/536,224

(22) PCT Filed: Nov. 20, 2003
(86) PCT No.: PCT/IB03/05297

§ 371 Date: May 24, 2005

(30) Foreign Application Priority Data
Nov. 27, 2002 (EP) 02292933.5

(51) Int. Cl. H04N 11/04

(52) U.S. Cl. 375/240.13

(57) ABSTRACT

The invention relates to a method of encoding a sequence of frames, by means of a three-dimensional subband decomposition applied to successive groups of frames together with motion estimation and compensation steps. As these steps lead to some unconnected pixels that highly impact the resulting picture quality, it is proposed, according to the invention, to reduce the number of unconnected pixels by performing, when a motion vector points from a current frame B to a sub-pixel position in a previous reference frame A, a truncation of said motion vector to point to an integer pixel of said previous frame located in the neighboring of said position and depending on it.

The present invention generally relates to the field of data compression and, more specifically, to a method of encoding a sequence of frames which are composed of picture elements (pixels), said sequence being subdivided into successive groups of frames (GOFs) themselves subdivided into successive pairs of frames (POFs) including a previous frame A and a current frame B, said method performing a three-dimensional (3D) subband decomposition involving a filtering step applied, in said sequence considered as a 3D volume, to the spatial-temporal data which correspond to each GOF, said decomposition being applied to said GOFs together with motion estimation and compensation steps performed in each GOF on saids POFs A and B and on corresponding pairs of low-frequency temporal subbands (POSs) obtained at each temporal decomposition level, this process of motion compensated temporal filtering leading in each previous frame A on the one hand to connected pixels, that are filtered along a motion trajectory corresponding to motion vectors defined by means of said motion estimation steps, and on the other hand to a residual number of so-called unconnected pixels, that are not filtered at all.

The invention also relates to a computer-readable programme code embodied in a computer-usable medium for causing a computer system to perform such an encoding method when said programme is implemented by means of a processor.

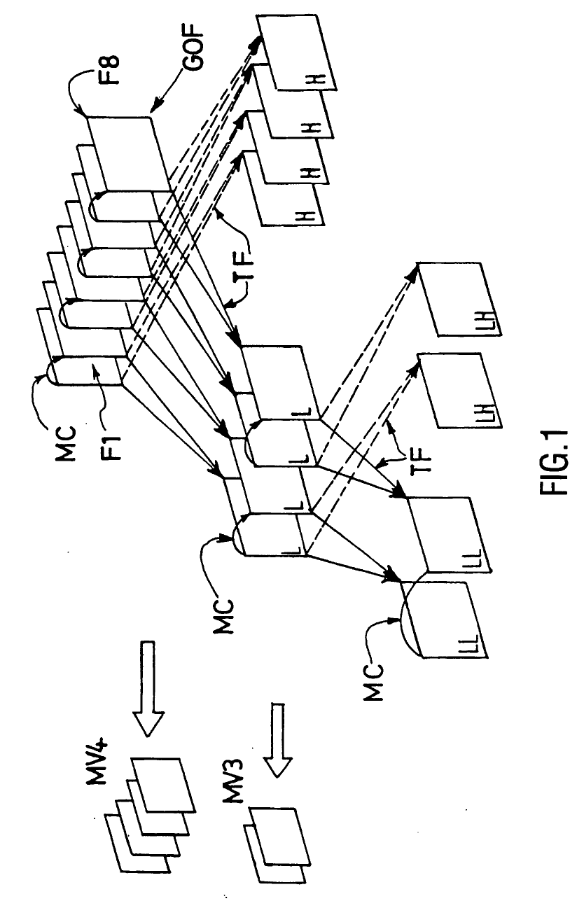

In recent years, three-dimensional (3D) subband analysis has been more and more studied for video compression. A 3D, or (2D+t), wavelet decomposition of a sequence of frames considered as a 3D volume indeed provides a natural spatial resolution and frame rate scalability. The coefficients generated by the wavelet transform constitute a hierarchical pyramid in which the spatio-temporal relationship is defined thanks to 3D orientation trees evidencing the parent-offspring dependencies between coefficients, and the in-depth scanning of the generated coefficients in the hierarchical trees and a progressive bitplane encoding technique lead to the desired quality scalability. The practical stage for this approach is to generate motion compensated temporal subbands using a simple two taps wavelet filter, as illustrated in FIG. 1 for a group of frames (GOF) of eight frames.

In the illustrated implementation, the input video sequence is divided into Groups of Frames (GOFs), and each GOF, itself subdivided into successive couples of frames (that are as many inputs for a so-called Motion-Compensated Temporal Filtering, or MCTF module), is first motion-compensated (MC) and then temporally filtered (TF). The resulting low frequency (L) temporal subbands of the first temporal decomposition level are further filtered (TF), and the process may stop when there is only two temporal low frequency subbands left (the root temporal subbands), each one representing a temporal approximation of the first and second halves of the GOF. In the example of FIG. 1, the frames of the illustrated group are referenced F1 to F8, and the dotted arrows correspond to a high-pass temporal filtering, while the other ones correspond to a low-pass temporal filtering. Two stages of decomposition are shown (L and H=first stage; LL and LH=second stage). At each temporal decomposition level of the illustrated group of 8 frames, a group of motion vector fields is generated (in the present example, MV4 at the first level, MV3 at the second one).

When a Haar multiresolution analysis is used for the temporal decomposition, since one motion vector field is generated between every two frames in the considered group of frames at each temporal decomposition level, the number of motion vector fields is equal to half the number of frames in the temporal subband, i.e. four at the first level of motion vector fields and two at the second one. Motion estimation (ME) and motion compensation (MC) are only performed every two frames of the input sequence, and generally in the forward way. Using these very simple filters, each low frequency temporal subband (L) represents a temporal average of the input couples of frames, whereas the high frequency one (H) contains the residual error after the MCTF step.

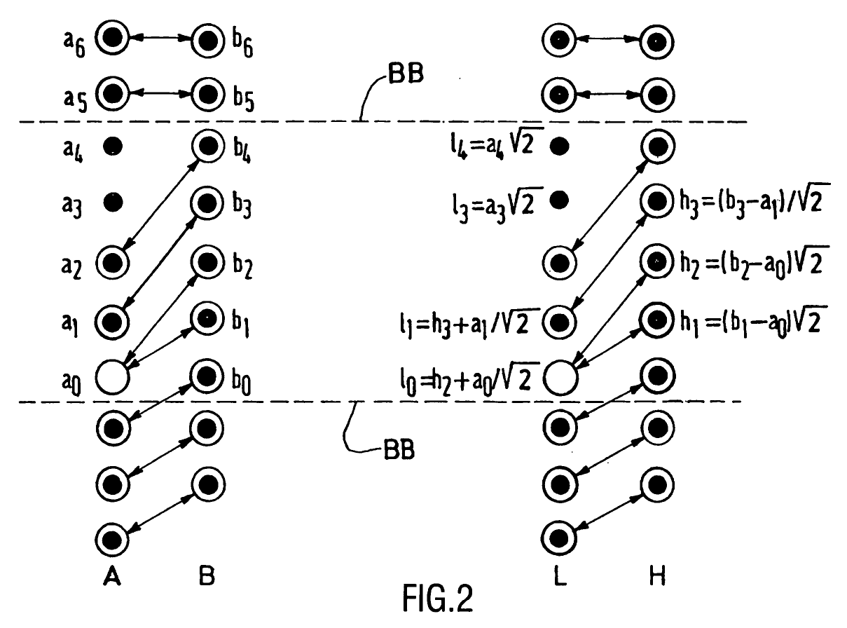

Unfortunately, due to the nature of the motion in the scenes and the covering/uncovering of the objects, the motion compensated temporal filtering may raise the problem of unconnected picture elements (or pixels), which are not filtered at all (or also the problem of double-connected pixels, which are filtered twice). A conventional solution for trying to solve that problem is described with reference to FIG. 2 that shows unconnected (and double-connected) pixels in the case of an integer pixel motion compensation performed in a theoretical frame with only a pixel per column (the unconnected pixels are represented by black dots and the double-connected pixels by circles, while the other pixels, which are the connected pixels, are represented by black dots surrounded by circles).

For each successive pair of frames (a current frame B associated to the corresponding previous frame A), a pair of subbands, comprising a temporal low-subband L and a temporal high-subband H, is generated by filtering and decimation. As illustrated in FIG. 2, where block boundaries BB have been represented, a_{O} to a₆ are the pixels of the previous frame A, bₒ to b₆ the pixels of the current frame B, lₒ to l₆ the values of the low-pass coefficients in the temporal subband L, and hₒ to h₆ the values of the high-pass coefficients in the temporal subband H. The connected pixels (for instance, a₂) are filtered along the motion trajectory defined by means of a block matching method.

According to said conventional solution, for an unconnected pixel in the previous frame A (like a₃ or a₄ in FIG. 2), the original value is inserted into the temporal low subband. For a double-connected pixel in the previous frame A (like a_{O} in FIG. 2), an arbitrary choice is made for the pixel selected in the current frame B, provided that the decoder applies the same selection: in FIG. 2, h₂ has been selected instead of h₁, in order to compute l_{O} (it is proposed, for instance in the document “Motion-compensated 3D subband coding of video”, S. J. Choi and J. W. Woods, IEEE Transactions on Image Processing, vol. 8, no 2, February 1999, pp. 155-167, to scan the current frame from top to bottom and from left to right, and to consider for the computation of the low-pass coefficient the first pixel in the current frame pointing to it).

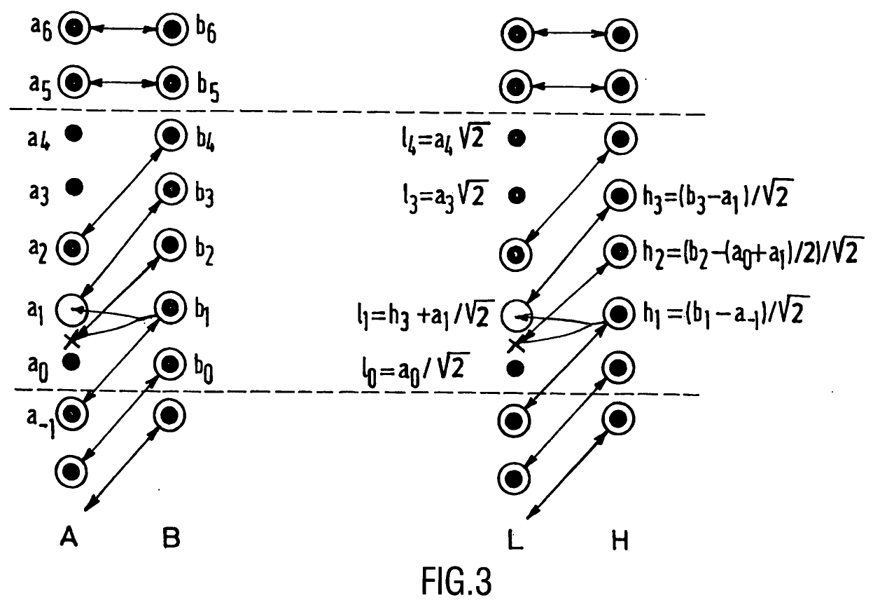

In case of half-pixel motion compensation, the management of the integer vectors is the same. For half-pixel vectors, the motion vector pointing to a half-pixel position in the previous frame A is truncated to point to an integer pixel in said previous frame, as indicated in FIG. 3 where a half-pixel position is represented by a cross, and the truncation mechanism is illustrated for the pixel b₂, with the bent arrow that shows that, in this case, the vector is truncated towards the top of the image (this truncation mechanism has to be exactly the same in the decoder, in order to guarantee a perfect reconstruction).

In all the cases, the number of unconnected pixels represents a weakness of the 3D subband coding/decoding approaches, because it highly impacts the resulting picture quality, especially for the high motion sequences or for the final temporal decomposition levels (for which the temporal correlation is not good).

It is therefore an object of the invention to avoid such a drawback and to propose a video encoding method with an improved coding efficiency due to a reduction of the number of unconnected pixels.

To this end, the invention relates to an encoding method such as defined in the introductory part of the description and in which the motion estimation steps comprise, in view of possible half-pixel motion compensations, a truncation mechanism according to which, when a motion vector points from the current frame B to a sub-pixel position in the corresponding previous frame A, said motion vector is truncated to point to an integer pixel of said previous frame, said vector truncation mechanism depending on the neighboring of said sub-pixel position.

The present invention will now be described, by way of example, with reference to the accompanying drawings in which:

FIG. 1 shows a two-stage temporal multiresolution analysis with motion compensation;

FIG. 2 illustrates the problem of unconnected (and double-connected) pixels, for integer pixel motion compensation;

FIG. 3 illustrates, for half-pixel motion vectors, the principle of vector truncation;

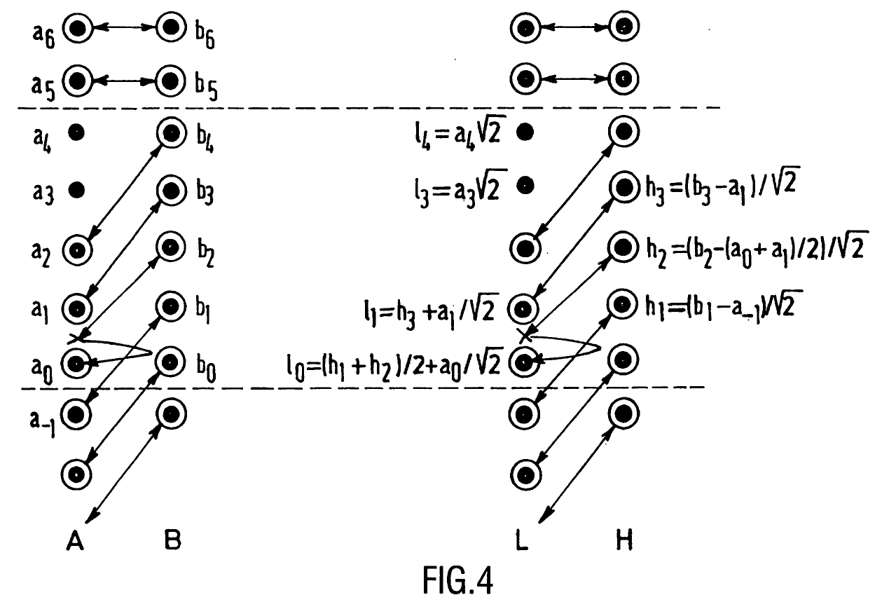

FIG. 4 illustrates the principle of the invention, according to which a half-pixel position is preferably associated with a position that corresponds to a pixel of the previous frame which was, before said association, still unconnected;

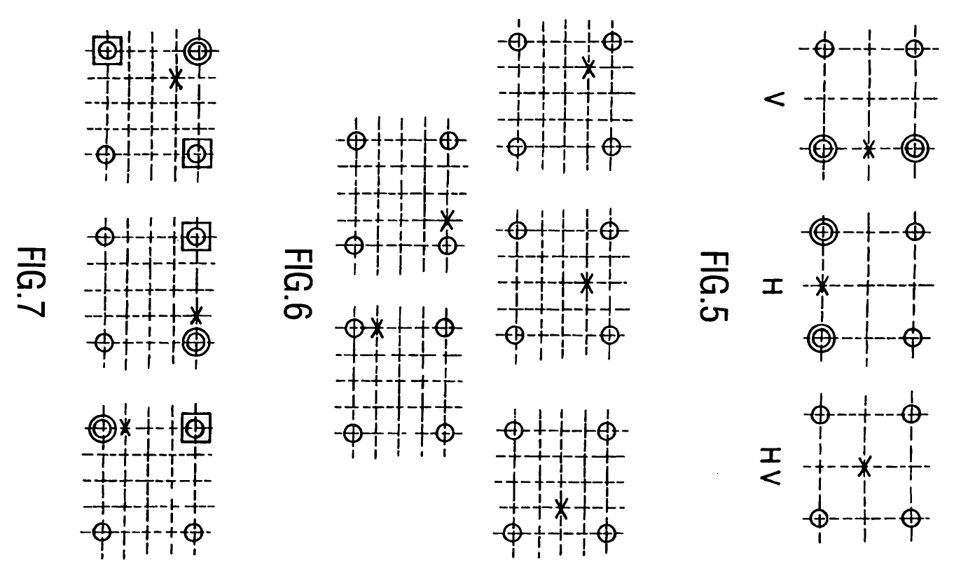

FIG. 5 illustrate the three different types of potential associations for half-pixel positions;

FIG. 6 gives five examples of potential associations for quarter-pixel positions;

FIG. 7 gives, with respect to FIG. 6, examples of extension of potential associations for quarter-pixel positions, in the case of a distance that is longer than the distance to the closest integer pixels.

The object of the invention is to reduce the number of unconnected pixels and therefore to improve the coding efficiency of the 3D subband approach. To this end, the principle of the invention is to modify the “systematic” vector truncation mechanism as illustrated in FIG. 3 and, from now on, to associate half-pixel positions with integer pixel ones, depending on the neighboring of the pixel under study. For example, in FIG. 3, the half-pixel position located between a_{O} and a₁, which is a reference position for the pixel b₂ in the current frame B, has been associated with the integer position a₁ by vector truncation to the top of the frame (see the curved arrow in FIG. 3), while the pixel a_{O} is still unconnected. In that particular case, it is then proposed, according to the invention, to associate the half-pixel position with a_{O} instead of a₁, which allows to reduce by one the number of unconnected pixels. This technical solution is illustrated in FIG. 4, where the bent arrow shows that the half-pixel position has been associated with the position a_{O} because the pixel a₁ was already connected, while the pixel a_{O} was still unconnected.

In order to guarantee a perfect reconstruction, the vector association mechanism thus proposed for half-pixel motion vectors must be identical at the decoder side.

As the only common information that can be used in a symmetric way on both encoding and decoding sides is the motion vector field, because it is the only information that is fully transmitted, the proposed solution at the encoding side will therefore be associated with a vector association protocol that can be mirrored at the decoding side.

As illustrated in FIG. 5, it may be noted that, in the previous frame A, each pointed position which is not an integer one can be a half-pixel position in the vertical direction (V) (it was the case illustrated in FIG. 3, in the prior art situation, or in FIG. 4, in the situation according to the invention), the horizontal direction (H), or both (HV). It can be noted that, in the V and H cases, there are, for the association with closer integer positions, only two natural positions, indicated by the double circles, while there are four potential neighbors in the HV case. For all these half-pixel positions, the vector association has to try to minimize the number of unconnected pixels, taking into account the integer vectors that are already naturally associated with a referenced integer position, for instance as follows. A possible example of implementation of this vector association mechanism is given in the instructions of the following algorithm:

for each pixel (i,j) in previous frame

{
status(i,j)=unconnected;
}

for each pixel (k,l) in the current frame with an integer vector (vₖ,vₗ)

{
if status(k−vₖ,l−vₗ)=unconnected
{
status(k−vₖ,l−vₗ)=connected;
associated(k−vₖ,l−vₗ)=(k,l)
}
}

for each pixel (k,l) in the current frame with a V half-pixel vector (vₖ,vₗ)

{
if status(k−vₖ,l−vₗ−0.5)=unconnected
{
status(k−vₖ,l−vₗ−0.5)=connected;
associated(k−vₖ,l−vₗ−0.5)=(k,l−0.5)
}
else if status(k−vₖ,l−vₗ+0.5)=unconnected
{
status(k−vₖ,l−vₗ+0.5)=connected;
associated(k−vₖ,l−vₗ+0.5)=(k,l+0.5)
}
}

for each pixel (k,l) in the current frame with a H half-pixel vector (vₖ,vₗ)

{
if status(k−vₖ−0.5,l−vₗ)=unconnected
{
status(k−vₖ−0.5,l−vₗ)=connected;
associated(k−vₖ−0.5,l−vₗ)=(k−0.5,l)
}
else if status(k−vₖ−0.5,l−vₗ)=unconnected
{
status(k−vₖ+0.5,l−vₗ)=connected;
associated(k−vₖ+0.5,l−vₗ)=(k+0.5,l)
}
}

for each pixel (k,l) in the current frame with a HV half-pixel vector (vₖ,vₗ)

{
if status(k−vₖ−0.5,l−vₗ−0.5)=unconnected
{
status(k−vₖ−0.5,l−vₗ−0.5)=connected;
associated(k−vₖ−0.5,l−vₗ−0.5)=(k−0.5,l−0.5)
}
else if status(k−vₖ−0.5,l+vₗ−0.5)=unconnected
{
status(k−vₖ−0.5,l−vₗ+0.5)=connected;
associated(k−vₖ−0.5,l−vₗ+0.5)=(k−0.5,l+0.5)
}
else if status(k−vₖ+0.5,l−vₗ−0.5)=unconnected
{
status(k−vₖ+0.5,l−vₗ−0.5)=connected;
associated(k−vₖ+0.5,l−vₗ−0.5)=(k+0.5,l−0.5)
}
else if status(k−vₖ+0.5,l−vₗ+0.5)=unconnected
{
status(k−vₖ+0.5,l−vₗ+0.5)=connected;
associated(k−vₖ+0.5,l−vₗ+0.5)=(k+0.5,l+0.5)
}
}

This algorithm allows to store in a table the status of the pixels of the reference frame, thanks to “status (i,j)” and as soon as the current frame is processed (more precisely, each pixel of the current frame). Said table “status (i,j)” is initialized to “unconnected” at the beginning of the processing, and each pixel of the current frame is processed in the same order as the scanning order. As soon as an unconnected pixel of the reference frame becomes “connected”, “status (i,j)” also is modified and becomes “connected”. At any moment, the situation is therefore known thanks to this table.

It is important to note that the above-given disclosure is only illustrative and that the present invention is not limited to the aforementioned implementation. Although the invention has been described mainly in the context of half-pixel motion compensation, it can be successfully applied to a motion compensation with a sub-pixel accuracy different from half-pixel accuracy. Potential associations for some cases of quarter-pixel positions are for example illustrated in FIG. 6 (where the simple circles correspond to integer positions, the crosses to a quarter pixel position, and the double circles to the natural associated integer positions). The associations can also be extended to integer pixels with a distance that is longer than the distance to closer integer pixels, which is illustrated in FIG. 7 (where these integer positions with a longer distance are indicated by means of circles surrounded by squares): in a second choice, if the closer integer pixel is already connected, the vector association mechanism selects these alternate integer positions.

1. A method of encoding a sequence of frames which are composed of picture elements (pixels), said sequence being subdivided into successive groups of frames (GOFs) themselves subdivided into successive pairs of frames (POFs) including a previous frame A and a current frame B, said method performing a three-dimensional (3D) subband decomposition involving a filtering step applied, in said sequence considered as a 3D volume, to the spatial-temporal data which correspond to each GOF, said decomposition being applied to said GOFs together with motion estimation and compensation steps performed in each GOF on saids POFs A and B and on corresponding pairs of low-frequency temporal subbands (POSs) obtained at each temporal decomposition level, this process of motion compensated temporal filtering leading in each previous frame A on the one hand to connected pixels, that are filtered along a motion trajectory corresponding to motion vectors defined by means of said motion estimation steps, and on the other hand to a residual number of so-called unconnected pixels, that are not filtered at all, said motion estimation steps comprising, in view of possible half-pixel motion compensations, a truncation mechanism according to which, when a motion vector points from the current frame B to a sub-pixel position in the corresponding previous frame A, said motion vector is truncated to point to an integer pixel of said previous frame, said vector truncation mechanism depending on the neighboring of said sub-pixel position.

2. An encoding method according to claim 1, wherein said vector truncation mechanism is implemented by means of a vector truncation operation performed either to the top of each previous frame A or to the bottom of said frame according to the fact that the closer integer pixel is connected or unconnected, in order to associate the concerned sub-pixel position to an integer pixel that was still unconnected before said association.

3. An encoding method according to claim 2, wherein said vector truncation mechanism is implemented for all the positions that are pointed within a pair of frames or subbands and are a half-pixel position in the vertical position, the horizontal direction or both, the vector truncation operation being done by means of a natural association to the closer integer pixel that was still unconnected before said association.

4. An encoding method according to claim 2, wherein said vector truncation mechanism is implemented for all the positions that are pointed within a pair of frames or subbands and are a quarter-pixel position in the vertical direction, the horizontal direction or any transversal direction, the vector truncation operation being done by means of a natural association to the closer integer pixel that was still unconnected before said association.

5. An encoding method according to claim 2, wherein said vector truncation mechanism is implemented for all the positions that are pointed within a pair of frames or subbands and are a quarter-pixel position in the vertical direction, the horizontal direction or any transversal direction, the vector truncation operation being done, if the closer integer pixel was already connected, by means of an association to an unconnected integer pixel with a distance that is longer than the distance to the closest integer pixels.

6. A computer-readable programme code embodied in a computer-usable medium for causing a computer system to perform an encoding method according to claim 1, when said programme is implemented by means of a processor.

7. An encoding device comprising a processor that includes a computer-readable programme code according to claim 6.
